(19) United States
(12) Patent Application Publication
(10) Pub. No.: US 2018/0111149 A1
(43) Pub. Date: Apr. 26, 2018

(54) METHOD AND EQUIPMENT FOR TERRAFORMING MARTIAN ATMOSPHERIC DENSITY AND SURFACE TEMPERATURE

(71) Applicant: Jerome Drexler, Los Altos Hills, CA (US)

(72) Inventor: Jerome Drexler, Los Altos Hills, CA (US)

(21) Appl. No.: 15/714,659

(22) Filed: Sep. 25, 2017

Related U.S. Application Data
(60) Provisional application No. 62/413,026, filed on Oct. 26, 2016.

(51) Int. Cl. B05B 13/00; B64G 1/10; F42B 12/50

(52) U.S. Cl. CPC B05B 13/005; B64G 1/16; F42B 12/50; B64G 1/10

(57) ABSTRACT

A terraforming installation has a set of one or more bases to facilitate localized heating of a polar icecap in the presence of ambient flux of cosmic rays and muons. Each base includes equipment for deploying deuterium-containing particle fuel material over and onto the polar icecap, the material interacting with the ambient flux of cosmic rays and muons to generate kinetic-energy-containing products. The equipment may include any of one or more guns for projecting shells, orbital platforms releasing packages, and rovers dispersing the fuel material over designated areas of a polar ice cap. In one embodiment, a package of deuterium-containing particle fuel material is in the form of an artillery shell comprising a shell wall encasing the fuel material with a fuse and chemical explosive charge activated by the fuse to disperse the material at a targeted location and altitude. In another embodiment, local space heating units use micro-fusion reactions from disks coated with the particle fuel material to radiate thermal energy onto the icecap surface.

### CROSS-REFERENCE TO RELATED APPLICATION

This application claims priority under 35 U.S.C. 119(e) from prior U.S. provisional application 62/413,026 filed on Oct. 26, 2016.

### TECHNICAL FIELD

The present invention relates to inducement of controlled muon-catalyzed nuclear fusion, as well as fusion obtained from bombardment with high-energy particles (particle-target fusion), to generate heat for sublimating or melting dry ice and water ice in Martian polar ice caps and subsurface permafrost.

### BACKGROUND ART

In recent years, there have been proposals to send further spacecraft to Mars in 2018 and then manned space vehicles to Mars beginning around 2024-2030. One such development project is the Interplanetary Transport System (formerly known as the Mars Colonial Transporter) by the private U.S. company SpaceX, with plans for an uncrewed preparatory mission beginning in 2022 followed by the first crewed flights as early as 2024. Other proposals (e.g. Mars Base Camp) would send astronauts to Mars orbit or one of its moons as early as 2028. The first trips will be exploratory missions with only temporary human occupation. Permanent colonies should become possible eventually, wherein colonists live within a small bubble of Earth-like surface conditions, regulating air pressure, oxygen and carbon dioxide levels, temperature, radiation shielding, and availability of potable water sufficient to support human life, plant growth for food production. This will still require considerable support for resources and maintenance from sponsoring nation states and private companies on Earth. But the ultimate challenge is terraforming Mars, that is to change its natural infrastructure and overall conditions to match that of Earth as closely as possible. Scientists and technologists are already thinking up potential strategies and technological processes needed to accomplish this terraforming feat.

Earth and Mars are quite different in many important ways. Earth orbits the Sun at 150 million kilometers (1 A.U. or Astronomical Unit) distance, while Mars' more eccentric orbit ranges from 1.38 to 1.67 A.U. distance, an average of 50% further away. Partially because of this, although the mean surface temperature on Earth is 288K (15° C.), Mars is much colder with a mean surface temperature of 210K (−63° C.). Only summer daytime high temperatures are a barely adequate 290K (17° C.). Earth's mass of 6.0×10²⁴ kg and equatorial radius of 6378 km provide a surface gravity of 980 cm/s² or 1 G. Mar's mass of 6.4×10²³ kg (11% that of Earth) and equatorial radius of 3396 km provide a surface gravity of 371 cm/s² or 0.376 G. Earth also has a geomagnetic field of about 30 μT (0.3 gauss) extending outward about 65,000 km or 10 Earth radii on the sunward side to protect our planet from the solar wind. Mars for many billions of years has had no protective magnetic field, so that the solar wind has gradually eroded or stripped Mars of much of its atmosphere. Earth has a surface atmospheric pressure of about 100 kPa (1 bar), while Mars' atmosphere averages only about 600 Pa (0.006 bar) and even at the lowest point of the Hellas Planitia impact basin only amounts to 1200 Pa (0.012 bar), which is equivalent to an altitude on Earth of 31,000 m (about 3½ times higher than the summit of Mt. Everest). The atmospheric pressure has an annual variation of 26% as about 8 trillion metric tonnes of carbon dioxide seasonally sublimate and freeze from Mars' polar ice caps. Earth's atmosphere is breathable, with a dry composition by volume of about 78% N₂, 21% O₂, 0.9% Ar and 400 ppm CO₂; also, having varying amounts of water vapor (averaging around 1% at sea level). Mars atmosphere, besides its very thinness, is unbreathable. It has a composition of 96% CO₂, just under 2% each of N₂ and Ar, only 0.146% O₂, plus 600 ppm of CO. Water vapor in very dry Mars' atmosphere is only around 300 ppm. Earth has a protective ozone layer in its stratosphere, while Mars effectively has no ozone layer (an ozone layer with a concentration 300× lower than Earth's forms over Mars' southern pole in winter, but is otherwise absent). As such, the Martian surface is exposed to strong solar ultraviolet radiation that can kill even the hardiest of microbes. Liquid water covers 71% of Earth's surface. On Mars, the low atmospheric pressure and freezing temperatures rule out the presence of liquid water. Water doesn't melt at pressures below 612 Pa; it directly sublimates to a gas. Subsurface permafrost is known to exist at least to 1 m depth from latitude 60° poleward. The polar ice caps of Mars contain, besides CO₂ dry ice, considerable quantities of water ice, with an estimated 1.6 million cubic kilometers of frozen H₂O in the southern polar cap and a further 0.8 million cubic kilometers in the northern polar cap. The water ice is covered by the dry ice that seasonally sublimates then refreezes. If one could somehow melt the water ice (one would have to raise both temperature and atmospheric pressure), there is enough water present in the polar caps to cover the surface of Mars up to 11 m in depth.

Making conditions on Mars even slightly closer to those on Earth would seem to be a highly difficult, challenging, even daunting, task. At a bare minimum, even leaving the composition of Mars' atmosphere unchanged, its atmospheric pressure would need to be raised 40-fold to above 24 kPa, allowing astronauts or colonists to survive without a pressure suit using a simple mask and a portable supply of pure oxygen. (Even higher pressures are needed for lower oxygen mixes.) Fortunately, there is believed to be sufficient CO₂ ice on Mars to raise the atmospheric pressure above 30 kPa if released by planetary warming. This, in turn, would allow the reappearance of liquid water on Mars, at least in the low-lying basins.

Existing proposals to terraform Mars generally involve one or more of three basic approaches. One is to overcome the consequence of Mars' greater distance from the Sun by using orbiting space mirrors to reflect more of the available sunlight onto the planet. This is just barely feasible only if one limits the effort to illuminating and warming one or both polar ice caps. For example, a 125 km diameter mirror placed in stationary orbit approximately 214,000 km behind Mars to illuminate the southern ice cap should add about 27TW, enough to raise the polar temperature by about 5K. The enormous mass of such a mirror would require that it be manufactured in space. Even then, it would be an expensive undertaking. A second approach attempts to add both impact heat and material (including greenhouse gas material, such as ammonia) by directing one or more asteroids and/or comets toward the planet. This supplements what happened in the early history of Mars that brought the water and atmospheric gases that remain today on Mars. The impact energy from such a space object would be sufficient to initially raise the temperature by about 3K, if not countered by cooling effects from dust raised into the atmosphere by the impact. However, if directed toward one of the polar ice caps, it could also release enormous quantities of the CO₂ greenhouse gas frozen there. But steering a 10-billion-ton object into desired location on Mars would be logistically very difficult (and if successful would create a troubling precedent), and Mars would likely be uninhabitable in the immediate aftermath of any such impact. A third terraforming approach would be to manufacture, transport and introduce greenhouse gases more potent than CO₂ (such as halocarbons) into Mars atmosphere. However, manufacturing, storing and transporting the quantity of greenhouse gas material needed to effectively raise the Martian surface temperature by 5° C. over 20 years would consume about as much power as needed by a city of one million people, not to mention diverting raw materials and workers from other tasks. And it would need to be sustained since these gases would have a lifetime of 100 years in the Martian atmosphere. All these approaches aim to initially raise the temperature sufficiently to densify the atmosphere and create liquid oceans. Shielding plant life from UV radiation and converting the atmospheric gases to something breathable, while simultaneously sustaining the greenhouse effect, is yet another undertaking altogether.

Muon-catalyzed fusion was observed by chance in late 1956 by Luis Alvarez and colleagues during evaluation of liquid-hydrogen bubble chamber images as part of accelerator-based particle decay studies. These were rare proton-deuteron fusion events that only occurred because of the natural presence of a tiny amount of deuterium (one part per 6400) in the liquid hydrogen. It was quickly recognized that fusion many orders of magnitude larger would occur with either pure deuterium or a deuterium-tritium mixture. However, John D. Jackson (Lawrence Berkeley Laboratory and Prof. Emeritus of Physics, Univ. of California, Berkeley) correctly noted that for useful power production there would need to be an energetically cheap way of producing muons. The energy expense of generating muons artificially in particle accelerators combined with their short lifetimes has limited its viability as an earth-based fusion source, since it falls short of break-even potential.

Another controlled fusion technique is particle-target fusion which comes from accelerating a particle to sufficient energy to overcome the Coulomb barrier and interact with target nuclei. To date, proposals in this area depend upon using some kind of particle accelerator. Although some fusion events can be observed with as little as 10 KeV acceleration, fusion cross-sections are sufficiently low that accelerator-based particle-target fusion are inefficient and fall short of break-even potential.

It is known that abundant muons can be derived from the decay of cosmic rays passing through a planet's atmosphere. Cosmic rays are mainly high-energy protons (with some high-energy helium nuclei as well) with kinetic energies in excess of 300 MeV. Most cosmic rays have GeV energy levels, although some extremely energetic ones can exceed 10¹⁸ eV. FIG. 4 shows cosmic ray flux distribution at the Earth's surface after significant absorption by Earth's atmosphere has occurred. In near-Earth space, the alpha magnetic spectrometer (AMS-02) instrument aboard the International Space Station since 2011 has recorded an average of 45 million fast cosmic ray particles daily (approx. 500 per second). The overall flux of galactic cosmic ray protons (above earth's atmosphere) can range from a minimum of 1200 m⁻²s⁻¹sr⁻¹ to as much as twice that amount. (The flux of galactic cosmic rays entering our solar system, while generally steady, has been observed to vary by a factor of about 2 over an 11-year cycle according to the magnetic strength of the heliosphere.) In regions that are outside of Earth's protective magnetic field (e.g. in interplanetary space or on planets or moons lacking a strong magnetic field), the cosmic ray flux is expected to be several orders of magnitude greater. As measured by the Martian Radiation Experiment (MARIE) aboard the Mars Odyssey spacecraft, average in-orbit cosmic ray doses were about 400-500 mSv per year, which is at least an order of magnitude higher than on Earth.

It is known that as cosmic rays lose energy upon collisions with atmospheric dust, and to a lesser extent atoms or molecules, they generate elementary particles, including pions and then muons, usually within a penetration distance of a few cm. Typically, hundreds of muons are generated per cosmic ray particle from successive collisions. For example, near sea level on Earth, the flux of muons generated by the cosmic rays' interaction by the atmosphere averages about 70 m⁻²s⁻¹sr⁻¹. The muon flux is even higher in the upper atmosphere. These relatively low flux levels on Earth reflect the fact that both Earth's atmosphere and geomagnetic field substantially shields our planet from cosmic ray radiation. Mars is a different story, having very little atmosphere (only 0.6% of Earth's pressure) and no magnetic field, so that cosmic ray flux and consequent muon generation at Mars' surface is expected to be very much higher than on Earth's surface.

### SUMMARY DISCLOSURE

A set of terraforming equipment situated at one or more terraforming bases are provided, which endeavor to raise local temperatures near polar regions by means of muon-catalyzed and particle-target micro-fusion. Bases are set up at least near or in polar regions both around on the polar icecaps. Alternatively, or in addition, bases can include orbiting platforms from which packages can be deployed onto polar regions. Each base includes at least one gun or artillery piece for projecting a series of packages or shells that contain and disperse micro-fusion fuel material above and onto the surface of the polar icecaps.

The present invention takes advantage of the abundance of cosmic rays arriving from interplanetary space, and the abundance of muons generated on Mars or other planet with a thin atmosphere and weak (or no) magnetic field, which are available for free, to catalyze fusion events sufficient to produce heat for raising the Martian temperature over the polar ice caps. The cosmic rays and muons are available here for free and do not need to be generated artificially in an accelerator. One way to do this is to distribute fusion target material (pellets, chips or powder) over the surface of one or both polar ice caps, which will then interact with the incoming flux of cosmic rays and muons, thereby producing a combination of particle-target fusion and/or muon-catalyzed fusion. Warming the poles by 5K will begin the process of polar dry ice sublimating into the atmosphere to achieve an increased greenhouse effect that will lead to complete sublimation of the dry ice. Since the dry ice is at least 9 m thick, a tremendous quantity of CO₂ will enter the atmosphere, thereby raising the pressure sufficiently to sustain the presence of liquid water on at least the lower altitude portions of the Martian surface. Maintaining or even increasing such higher temperatures can lead to such melting of the water ice. While complete Earth-like conditions might not be achievable using this technique alone, in combination with one or more other techniques an initial goal of attaining at least 24 kPa pressures (a 40-fold increase over current levels) sufficient to allow astronauts to go out without needing a pressure suit would be a welcome first step.

The deuterium-containing “fuel” for the particle-target and/or muon-catalyzed fusion may be supplied in the form of solid LiD as chips, pellets or powder, or even heavy water (D₂O) ice. Muonic deuterium atoms can come much closer to the nucleus of a similar neighboring atom with a probability of fusing deuterium nuclei, releasing energy. Once a muonic molecule is formed, fusion proceeds extremely rapidly (on the order of 10⁻¹⁰ sec). One cosmic ray particle can generate hundreds of muons, and each muon can typically catalyze about 100 fusion reactions before it decays (the exact number depending on the muon “sticking” cross-section to any helium fusion products). Other types of fusion reactions besides D-D are also possible depending upon the target material. For example, another reaction is Li⁶+D→2He⁴+22.4 MeV, where much of the useful excess energy is carried as kinetic energy of the two helium nuclei (alpha particles). Additionally, any remaining cosmic rays can themselves directly stimulate a fusion event by particle-target fusion, wherein the high energy cosmic ray particles (mostly protons, but also helium nuclei) bombard relatively stationary target material. When bombarded directly with cosmic rays, the lithium may be transmuted into tritium which could form the basis for some D-T fusion reactions. Although D-D fusion reactions occur at a rate only 1% of D-T fusion, and produce only 20% of the energy by comparison, the freely available flux of cosmic rays and their generated muons should be sufficient to yield sufficient fusion energy output for practical heating over the surface of the polar ice cap.

The present invention achieves nuclear fusion using deuterium-containing target material, and the ambient flux of cosmic rays and generated muons that are already naturally present. Since the amount of energy is generally much less than the multi-kiloton yields of atomic weapons and is needed on a continuous sustained basis, “micro-fusion” is the term used here to refer to fusion energy outputs of not more than 10 gigajoules per second (2.5 tons of TNT equivalent per second), to thereby exclude macro-fusion type explosions.

The optimum concentration of the target material for the particle-target and muon-catalyzed fusion may be determined experimentally based on the abundance of cosmic rays with a view to maintaining fusion events at a rate adequate for generating the desired heat, while avoiding any possibility of runaway fusion. At a minimum, since both particle-target fusion and muon-catalyzed fusion, while recognized, are still experimentally immature technologies (since measurements have only been conducted to date on Earth using artificially accelerated particles and generated muons from particle accelerators), various embodiments of the present invention can have research utility to demonstrate feasibility in environments beyond Earth's protective atmosphere and/or geomagnetic field, initially above Earth's atmosphere (e.g. on satellite platforms) for trial purposes, and then on the Moon or the surface of Mars, in order to determine optimum parameters for various utilities in those environments. For example, the actual number of fusion reactions for various types of fusion fuel sources and target configurations, and the amount of heat that can be derived from such reactions, are still unknown and need to be fully quantified to improve the technology.

### BRIEF DESCRIPTION OF THE DRAWINGS

FIG. 1 is a schematic plan view of a terraforming base with micro-fusion fuel material deployment equipment for dispersing the fuel material over and onto the surface of a local area of a planetary polar icecap.

FIG. 2 is a schematic sectional view of one possible projectile package or shell for containing and dispersing the micro-fusion fuel material.

FIG. 3 is a schematic perspective of a localized space heating device that can be deployed from a terraforming base at key locations over a polar icecap surface.

FIG. 4 is a graph of cosmic ray flux at the Earth surface versus cosmic ray energy, after very significant cosmic ray absorption by Earth's atmosphere has occurred.

### DETAILED DESCRIPTION

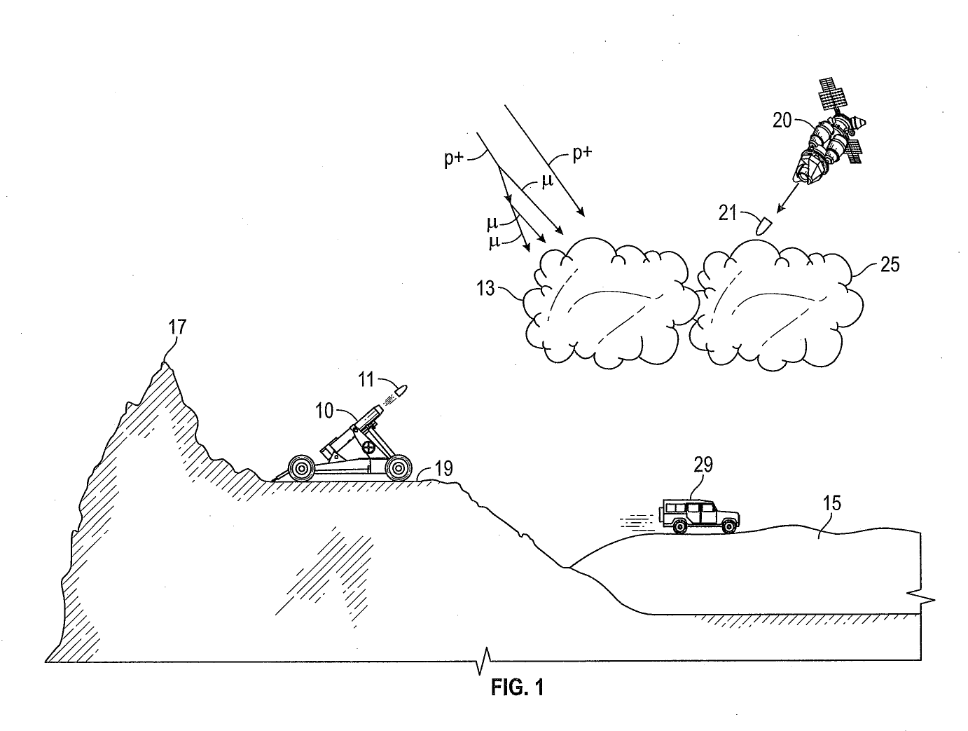

Several methods are available for distributing deuterium-containing fusion “fuel” material over one or both polar ice caps. With reference to FIG. 1, one technique is to project the fusion target material skyward, much like fireworks or artillery, from designated bases around the polar region(s). From such bases, one sends up the “fuel” material from artillery shells 11 loaded with the fusion target chips or pellets, which disperse before landing, e.g. by chemical explosion, as a localized cloud 13 of material that will settle over the ice cap surface 15. For example, a 120 mm stratosphere antiaircraft gun 10, or similar apparatus, can fire a series of projectiles 11, e.g. once every minute, 5-8 km high and up to 25-30 kilometers downrange in Mars' lower gravity and thinner atmosphere. Shell projection sites will be located near the edge or on top of the polar icecap, preferably (if such a site is available) at a location with higher altitude for achieving maximum range of the projectiles 11. For example, one might choose to situate bases for the guns 10 on suitable flat plateau regions 19 near the tops of a mountains 17. Any convenient method that brings the material to the desired altitude for dispersal can be employed.

Alternatively, packages 21 of fusion target material might be dropped from one or more satellite platforms 20, e.g. in a polar or near-polar orbit that brings such orbiting platforms over the icecaps. The satellite-dropped packages 21 enter the atmosphere and release the material as a localized cloud 25 at a predetermined altitude. Deploying a specialized fleet of such spacecraft, the dropped containers 21 of the fusion target chips or pellets could be dispersed by means of chemical explosion at some specified altitude that leads to wide distribution of the fusion target particles over the ice cap surface 15.

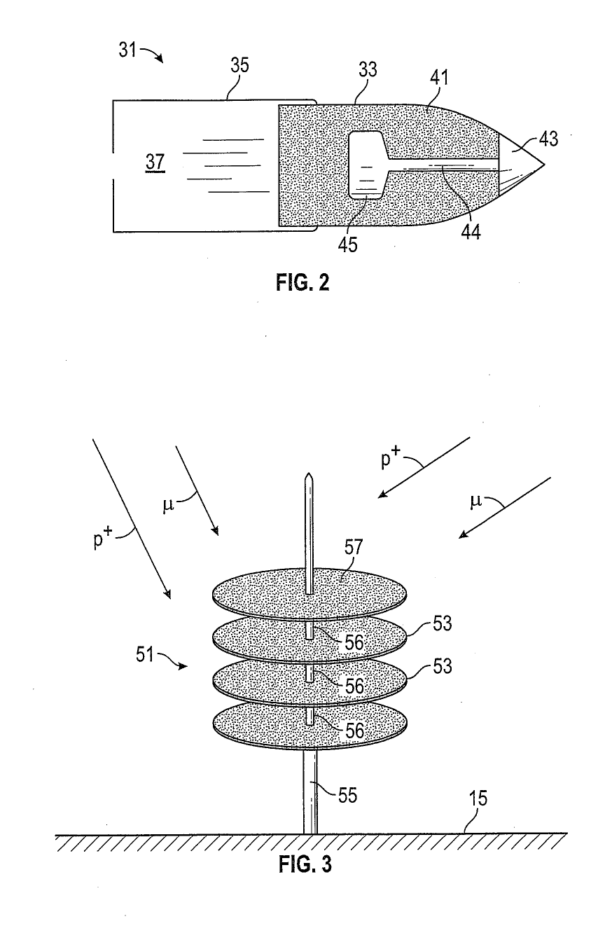

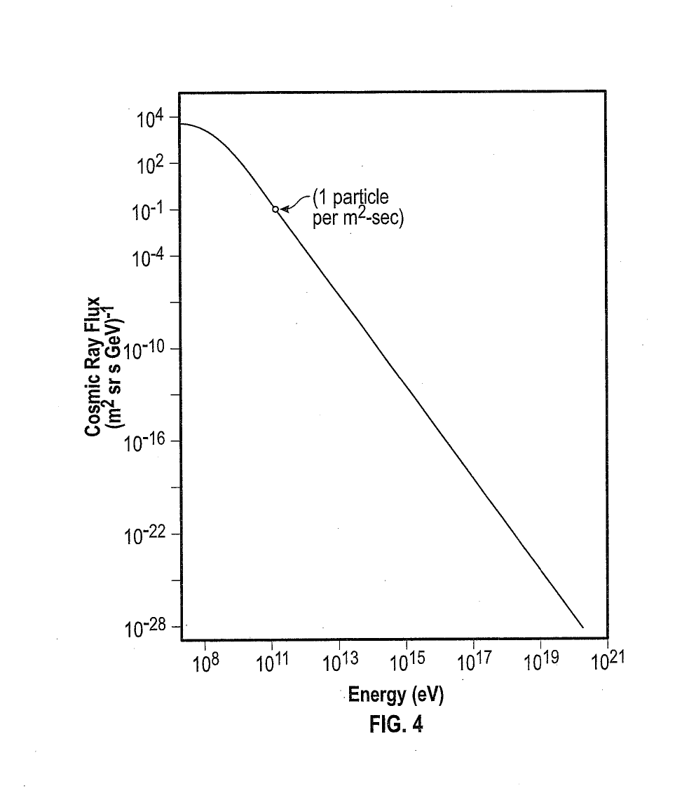

A variety of known pyrotechnic or artillery shell structures might be employed, the difference being in the content of the material to be dispersed. As seen in FIG. 2, one possible structure comprises a shell 31 having a shell wall 33 containing the micro-fusion fuel material 41 and attached at the back to a cartridge case 35 with solid-fuel propellant 37 for launching the shell to a targeted location. Within the shell wall 33, for example at or near its tip is a fuse 43 for triggering the release and dispersal of the material 41, e.g. by explosive means including a central ignition tube 44 leading to a shell-bursting charge 45. The fuse 43 can be based upon timing, barometric pressure, a determined position, or other known mechanisms to ensure that dispersal of the fuel material 41 occurs at an optimal altitude over the targeted location. Packages dropped from an orbiting platform will be similar, but will also include some form of heat shielding for atmospheric reentry, and any cartridge and propellant structure, if included, would be for steering the package to the target location.

Whether fired from a gun or dropped from an orbiting platform, the shells or other form of package should disperse the micro-fusion fuel elements at a desired altitude for optimal dispersal of the fuel material over the icecap surface. Various mechanisms for triggering a chemical explosion of the package could be employed. Triggering technologies can include any one or more of (1) a timer, (2) an altitude detector, (3) a “geographical” location detector, or (4) laser or microwave beam(s) directed at the package from one or more orbital or surface bases. Optimal altitude for dispersing the material may depend upon atmospheric conditions above the release site, as well as the presence of any habitations or critical infrastructure in the vicinity. Use of such triggering technologies would thus facilitate cooperation among the various parties participating in the various scientific, commercial, and terraforming operations by ensuring that the terraforming operations like the release of micro-fusion fuel doesn't adversely interfere with other planned activities, e.g. near surface bases.

In some cases, the desired elevation for dispersal could be at the surface itself, e.g. directly from a landing field. In that case, the package will have landed on the icecap before trigger technology is activated. The targeted release of packages from orbit or the chosen trajectories of shells fired from a gun will ensure suitable wide-range distribution of the packages or shells themselves, while the explosive trigger will locally disperse the micro-fusion fuel material from the packages at their various landing sites. Alternatively, the material might be sown by a suitable set of ground rovers 29 (possibly autonomously operated) that traverse the icecap 15 while distributing micro-fusion fuel material over the icecap surface along their respective routes. The rovers themselves might be powered by micro-fusion energy.

The fuel can be solid Li⁶D in powder, chip or pellet form, D₂O ice crystals, or even droplets of (initially liquid) encapsulated D₂. Because of the presence of water ice (in addition to frozen CO₂) at the poles and the chemical reactivity of Li⁶D, the powder, chip or pellets may be coated to protect the Li⁶D material from direct exposure to water ice. Alternatively, Li⁶OD might be used as a fuel material. Packages may be shielded to reduce or eliminate premature fusion events (e.g. during transport through space or while in storage locations on Mars itself) until delivered to the desired locations. Soon after a projectile (or package dropped from a satellite) has reached a desired altitude, the package releases its target material to locally disperse it over an area above the polar ice cap. The target material will slowly settle over the ice cap surface and be exposed to both cosmic rays and their generated muons. As cosmic rays collide with the fusion targets and dust, they form muons that are captured by the deuterium and cause fusion. Other types of fusion reactions may also occur (e.g. D-T, using tritium generated by cosmic rays impacting the lithium; as well as Li⁶-D reactions from direct cosmic ray collisions). To assist muon formation, especially when D₂O or D₂ is used, the target package may contain up to 20% by weight of added particles of fine sand or dust. If encapsulated D₂ is used, any leakage of D₂ should preferably be slow enough to remain near the polar icecap region for a sufficient time to yield useful amounts of surface heating before dissipating.

The muon-catalyzed fusion reaction, where the muons are generated from cosmic rays, may be used to create successive miniature suns above the polar ice cap. The miniature suns shining upon the ice cap surface, a kind of “external” combustion in the sky, will heat the local area below leading to sublimation of the ice cap's CO₂ dry ice. As such they will function in much the same way the sun does to provide heat by infrared radiation. Even after the fusion target material has settled onto the ice cap surface it will continue to be exposed to cosmic ray and muon collisions until the fuel material is completely exhausted. As the dry ice sublimates, the target material (except for D₂ material, if used) will continue to remain on the surface.

Once water ice is exposed, the water will likewise be sublimated until the atmospheric pressure has reached a sufficient level for melting to begin. Thereafter, the form of target material being used can switch to chips, pellets or capsules that will float upon the liquid water after settling, and continue being exposed to cosmic rays and muons.

With reference to FIG. 3, yet another method is to set up a series of micro-fusion space heaters 51 at various locations or bases over the polar ice caps. Each space heater 51 could comprise a series of a dozen plates or disks 53 slid onto a rod 55, and alternating with spacers 56, that may have tiny chips of Li⁶D, or other pellets of fusion target material 57, bonded to those plates or disks 53. The Li⁶D chip material 57 may be coated with an inert material to protect it against adverse chemical reaction during manufacture, transport and in the launch vehicle. The plates 53 containing the fusion material should also be shielded against premature interactions with cosmic rays during its long travel to Mars, and until they are set up at the polar cap sites themselves. When subject to cosmic ray collisions, the disks become hot from the resulting fusion reactions and radiate the heat onto the polar ice cap.

Additionally, for optimum dispersal of the heat to a larger area of the ice cap, the kinetic energy of the fusion products can be transferred as heat to a metal lining or tubes of water coupled to a heat exchanger laid out over the ice cap surface. The optimum size of the tiny chips of fusion fuel material and the spacing between them can be determined with routine experimentation to ensure an adequate chain of fusion events that generate useful heat without runaway fusion.

Despite the lack of an atmosphere or significant water on the Moon, various aspects of the method and its associated equipment can still be tested and then optimized at lunar facilities before being deployed on Mars. For example, micro-fusion fuel material can be dispersed on the lunar surface and the amount of surface temperatures increase measured relative to control areas without such material. Micro-fusion space heaters could likewise be tested in a lunar environment. The Moon provides a convenient site for testing because of the ability to return to Earth, if needed, in days instead of months, and because real-time interaction with engineers and scientists on Earth is still possible without the typical 20 minute or longer time delays involved in communications with Mars. Gaining experience, and demonstrating safe operation, from such test operations on the Moon will allow these new techniques to be confirmed and perfected before committing to their deployment on Mars or any other planet or moon in need of terraforming.

What is claimed is:

1. A terraforming installation having a set of one or more bases to facilitate localized heating of a polar icecap in the presence of ambient flux of cosmic rays and muons, each base comprising equipment for deploying deuterium-containing particle fuel material over and onto the polar icecap, the fuel material interacting with the ambient flux of cosmic rays and muons to generate kinetic-energy-containing products.

2. The installation as in claim 1, wherein the equipment comprises at least one gun and a set of shell projectiles to be shot from the at least one gun to target areas for fuel material dispersal.

3. The installation as in claim 2, wherein the shell projectiles contain a chemical explosive and a fuse configured to disperse the fuel material as a localized cloud at a specified altitude relative to the target areas.

4. The installation as in claim 1, wherein at least one base is a platform in an orbit capable of releasing fuel packages toward targeted areas over the polar icecap, each of the packages configured to disperse the fuel material as a localized cloud at a specified altitude over the targeted areas.

5. The installation as in claim 1, wherein the equipment comprises a local space heater set up at a designated location on the polar icecap, the space heater including a set of discs or plates coated with the deuterium-containing particle fuel material.

6. The installation as in claim 1, wherein the equipment comprises at least one rover directed from the base over a specified region of the polar ice cap, each rover dispersing the deuterium-containing particle fuel material onto the polar icecap as it travels.

7. The installation as in claim 1, wherein the deuterium-containing particle fuel material comprises Li⁶D or Li⁶OD solid chips, pellets or powder.

8. The installation as in claim 1, wherein the deuterium-containing particle fuel material comprises D₂O.

9. The installation as in claim 1, wherein the deuterium-containing particle fuel material comprises encapsulated D₂.

10. The installation as in claim 1, wherein the deuterium-containing particle fuel material also contains up to 20% by weight of added particles of fine sand or dust.

11. A package of deuterium-containing particle fuel material in the form of an artillery shell comprising a shell wall encasing the fuel material with a fuse and chemical explosive charge activated by the fuse.

12. The package as in claim 11, wherein the artillery shell further comprises a cartridge case containing a propellant for projecting the shell to a targeted location.

13. The package as in claim 11, wherein the fuse comprises a timer for activating the explosive charge at a specified time after projection of the shell.

14. The package as in claim 11, wherein the fuse comprises an atmospheric pressure detector for activating the explosive charge at a specified altitude over a targeted location.

15. The package as in claim 11, wherein the fuse comprises a location detection system for activating the explosive charge when the shell reaches a targeted location.

16. The package as in claim 11, wherein the deuterium-containing particle fuel material comprises Li⁶D or Li⁶OD solid chips, pellets or powder.

17. The package as in claim 11, wherein the deuterium-containing particle fuel material comprises D₂O.

18. The package as in claim 11, wherein the deuterium-containing particle fuel material comprises encapsulated D₂.

19. The package as in claim 11, wherein the deuterium-containing particle fuel material also contains up to 20% by weight of added particles of fine sand or dust.
